(19) United States
(12) Patent Application Publication
(10) Pub. No.: US 2003/0236687 A1
(43) Pub. Date: Dec. 25, 2003

(54) System and method promoting tree maintenance by providing compensation for loss of a maintained tree

(76) Inventor: Douglas Hunt, Chester, NJ (US)

Correspondence Address: Mathews, Collins, Shepherd & McKay, P.A., Suite 306, 100 Thanet Circle, Princeton, NJ, 08540-3674, US

(21) Appl. No.: 10/464,090

(22) Filed: Jun. 17, 2003

Related U.S. Application Data
(60) Provisional application No. 60/390,981, filed on Jun. 24, 2002.

(51) Int. Cl. G06F 17/60

(52) U.S. Cl. 705/4

(57) ABSTRACT

The present invention relates to a system and method for promoting tree maintenance by providing compensation for loss of a maintained tree. In the method, it is determined if maintenance has been performed on the tree. A policy is established for providing compensation upon loss of the tree. A maintenance regime can be established for determining the necessary maintenance. If a loss occurs of a tree covered under the policy, the policyholder is compensated for the loss.

### CROSS REFERENCE TO RELATED APPLICATIONS

This application claims priority to U.S. Provisional Application No. 60/390,981, filed on Jun. 24, 2002 and entitled System and Method for Insurance of Trees, the disclosure of which is hereby incorporated by reference in its entirety.

### BACKGROUND OF THE INVENTION

1. Field of the Invention

The present invention relates to a method and system for providing compensation for loss of a maintained tree.

2. Description of Related Art

Management System for farms and forests are known. U.S. Pat. Nos. 5,963,733 and 6,041,173 describes a method and system for simulating forest management. The method and system simulate aspects of forest management including forestry operations, organization of cash flow, multiple land use management and environmental quality.

U.S. Pat. No. 5,897,619 describes a farm management system to process field-related data and verify that the configuration of the field allows the field to be insurable. The method validates claims of crop damage caused by weather.

Trees are a substantial investment for a homeowner or commercial property. Feeding and maintenance regimes can be used to enhance the longevity of the trees.

It is desirable to provide a method and system for promoting the maintenance of the tree by rewarding a customer with compensation for loss of a tree if scheduled tree maintenance has been performed on the tree.

### SUMMARY OF THE INVENTION

The present invention relates to a system and method for promoting tree maintenance by providing compensation for loss of a maintained tree. In the method, it is determined if maintenance has been performed on the tree. A maintenance regime can be established for determining the necessary maintenance. A policy is established for providing compensation upon loss of the maintained tree. Maintenance can include fertilization and insect maintenance. If a loss occurs of a tree covered under the policy, the policyholder is compensated for the loss. A report can be generated which provides details of the loss of the tree.

The present invention promotes performing maintenance on a tree by rewarding a policyholder with compensation if the policyholder has performed established maintenance.

The invention will be more fully described by reference to the following drawings.

### BRIEF DESCRIPTION OF THE DRAWINGS

FIG. 1 is a flow diagram of a method for promoting tree maintenance in accordance with the teachings of the present invention.

FIG. 2 is a schematic diagram of a policy for providing coverage of loss of a maintained tree.

FIG. 3 is a schematic diagram of a system for implementing the method of promoting tree maintenance in accordance with the teachings of the present invention.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

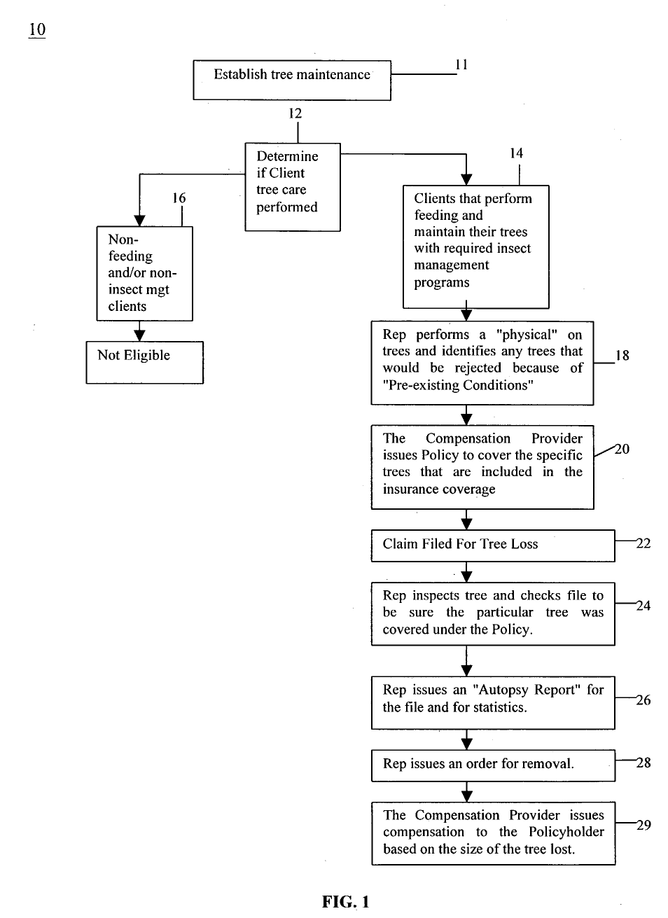

FIG. 1 is a flow diagram of a method for promoting tree maintenance by providing compensation for loss of a maintained tree 10 in accordance with the teachings of the present invention. In block 11, a fertilization and tree maintenance regime can be determined for a client. Alternatively, the client could have already determined a fertilization and maintenance regime. The regime is promoted to the client such that if the client performs the regime the client is rewarded by being eligible for coverage to provide compensation for loss of the maintained tree. For example, fertilization can include pressure injection fertilization. Maintenance can include, for example, insect maintenance.

In block 12, a decision is made as to whether a client performs fertilization and maintenance of their trees. If it is determined that the client has performed fertilization and maintenance, the client is determined to be eligible for coverage of compensation for loss in block 14. If it is determined that the client has not performed fertilization and maintenance, the client is determined to be ineligible for compensation for loss in block 16.

In block 18, an inspection is performed on the trees desired for coverage to identify any trees which have pre-existing conditions, such as insect infestation, disease or root disturbance. Trees identified with pre-existing conditions are not eligible for compensation for loss. In block 20, a compensation provider determines a policy which identifies particular trees which are included in the compensation coverage. The trees can be identified, for example, on a tree site plan illustration, by physically marking the trees or by a written description of species and location.

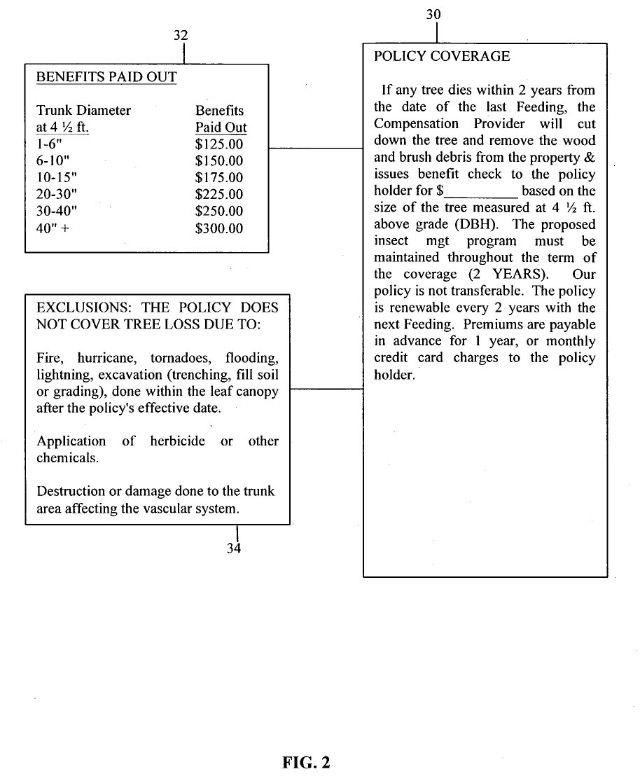

FIG. 2 illustrates an example of a policy. The policy recites in block 30 that if a tree dies within two years from the date of the last fertilization feeding, the compensation provider will cut down the tree and remove the wood and debris from the policy holder's property. Thereafter, benefits are paid to the policy holder in accordance with a schedule. An example schedule of benefits is shown in block 32. The policy can recite exclusions of coverage for example due to acts of God or customer activities. Example exclusions are shown in block 34.

Referring to FIG. 1, a client files a claim for a tree loss in block 22. A representative of the compensation provider, such as a central organization, inspects the tree of the client and the policy coverage to determine if a benefit is owed in block 24. In block 26, the compensation provider issues a report indicating loss of the tree and details concerning the death of the tree. The report can be stored and statistical information related to tree loss can be determined.

In block 28, the compensation provider issues an order for removal of the tree. In block 29, the compensation provider provides compensation to the policyholder in accordance with the insurance policy. The system and method of the present invention can provide compensation for trees which die from insects or disease and other stresses associated with an urban environment and provide an incentive for owners of trees to provide maintenance of their trees.

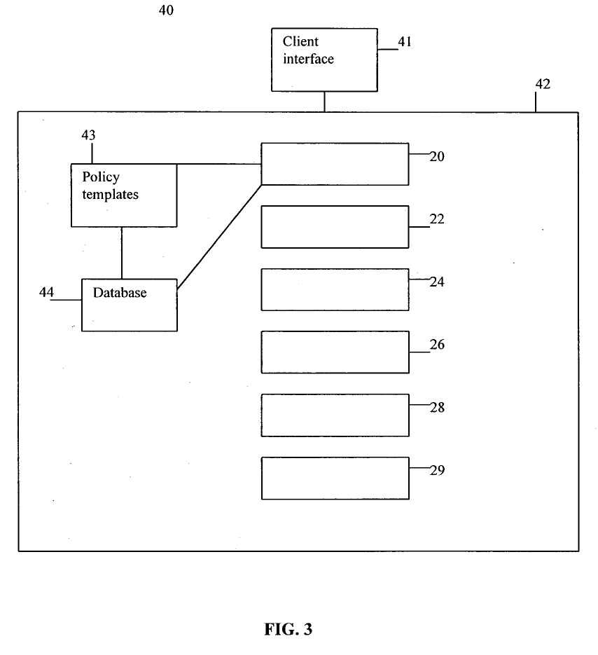

FIG. 3 is a schematic diagram of a system 40 for implementing the method for promoting tree maintenance by providing compensation for loss of a maintained tree. Client interface 41 receives client information for example personal information of the client and information of the trees to be insured. Organization control system 42 performs blocks 20-29 as software modules. Block 20 can interface with policy templates 43 defining examples of policy limitations and benefits in order to generate the insurance policy. The determined policy and policy templates can be stored in database 44. Reports generated in block 26 can also be stored in database 44.

It is to be understood that the above-described embodiments are illustrative of only a few of the many possible specific embodiments which can represent applications of the principles of the invention. Numerous and varied other arrangements can be readily devised in accordance with these principles by those skilled in the art without departing from the spirit and scope of the invention.

What is claimed is:

1. A method for providing compensation for loss of a maintained tree comprising the steps of:
determining if maintenance has been performed on said tree;
if maintenance has been performed, determining a policy for covering said tree;
determining a loss of said tree; and

2. compensating a policy holder of said policy an amount specified under said policy.

3. The method of claim 1 wherein said maintenance comprises fertilization.

4. The method of claim 2 wherein said fertilization comprises pressure injection fertilization.

5. The method of claim 1 wherein said maintenance comprises insect maintenance.

6. The method of claim 1 wherein said maintenance is determined by the step of determining a maintenance regime.

7. The method of claim 1 wherein before said step of determining a policy for covering said tree further comprising a step of inspecting said tree for identifying any preexisting conditions and trees identified with said preexisting conditions are not eligible for said policy.

8. The method of claim 1 further comprising the step of:
generating a report indicating said loss of said tree and details concerning death of said tree.

9. The method of claim 7 further comprising the step of storing said report and determining statistical information related to said loss of said tree.

10. The method of claim 1 wherein said step of determining loss of a tree further comprises inspecting said tree and determining if said tree was covered under said policy.

11. The method of claim 1 further comprising the step of providing removal of said tree after determining a loss of said tree.

12. A system for providing compensation for loss of a maintained tree comprising:
means for determining if maintenance has been performed on said tree;
means for determining a policy for covering said tree if maintenance has been performed;
means for determining a loss of said tree; and
means for compensating a policy holder of said policy an amount specified under said policy.

13. The system of claim 12 wherein said maintenance comprises fertilization.

14. The system of claim 13 wherein said fertilization comprises pressure injection fertilization.

15. The system of claim 12 wherein said maintenance comprises insect maintenance.

16. The system of claim 12 wherein said maintenance is determined by means for determining a maintenance regime.

17. The system of claim 12 wherein further comprising means for inspecting said tree for identifying any preexisting conditions and trees identified with said preexisting conditions are not eligible for said policy.

18. The system of claim 12 further comprising:
means for generating a report indicating said loss of said tree and details concerning death of said tree.

19. The system of claim 18 further comprising the means for storing said report and means for determining statistical information related to said loss of said tree from said stored report.

20. The system of claim 12 further comprising means for inspecting said tree and determining if said tree was covered under said policy.

21. The system of claim 12 further comprising means for providing removal of said tree after determining a loss of said tree.
